(19) United States
(12) Patent Application Publication
(10) Pub. No.: US 2006/0146838 A1
(43) Pub. Date: Jul. 6, 2006

(54) System and method for automatic and direct routing of information in a network

(75) Inventors: Thomas G. Hallin, Erie, CO (US); William N. Shores, Phoenix, AZ (US)

Correspondence Address: MOTOROLA, INC., LAW DEPARTMENT, 1303 E. ALGONQUIN ROAD, SCHAUMBURG, IL, 60196, US

(73) Assignee: Motorola, Inc.

(21) Appl. No.: 11/027,158

(22) Filed: Dec. 30, 2004

(51) Int. Cl. H04L 12/56; H04L 12/28

(52) U.S. Cl. 370/400

(57) ABSTRACT

A system and method of automatically routing a message between communication units in a network sends a first message (116) to a first server (106). A redirect message (118) is responsively received from the first server (106). The redirect message (118) comprises identification of a destination server (112) associated with a destination communication unit (119) and a target range. The target range includes a plurality of communication units associated with the destination server (112).

### FIELD OF THE INVENTION

This invention generally relates to transmitting communications in networks. More specifically, it relates to routing communications efficiently within these networks.

### BACKGROUND OF THE INVENTION

In telephony networks, calling patterns within the network change over time. For example, some calling routes within the network become overloaded and other routes are seldom used. The addition or deletion of new devices within the network may also cause the calling patterns to change. Routing tables within these networks store and track this type of information for later use. In one example, these tables are used as the basis for routing Session Initiation Protocol (SIP) based Internet Protocol (IP) messages within networks.

Previous systems use routing tables configured to store routing information. This information is entered manually by system administrators into the tables, which are stored on the system. Changes to the routing tables require close coordination between systems and are often performed at low traffic times to prevent network outages when systems are temporarily out of synchronization.

Several problems exist with the use of routing tables within these previous systems. For example, changes to the tables take a long time to propagate through the system resulting in the inefficient transmission of information. In addition, changes are required to be manually made. Because the changes are made manually, the process is labor intensive and costly. Furthermore, data entry errors may occur as the operator enters the information into the system.

### BRIEF DESCRIPTION OF THE DRAWINGS

FIG. 1 is a block diagram showing a system for automatically routing information in a wireless network according to various embodiments of the present invention;

FIG. 2 is a block diagram and flowchart showing one example of the routing of a first call in a wireless network according to various embodiments of the present invention;

FIG. 3 is a block diagram and flowchart showing one example of the routing of a second call made after the call shown in FIG. 2 in a wireless network according to various embodiments of the present invention;

FIG. 4 is a block diagram showing one example of the routing table 103 according to various embodiments of the present invention; and

FIG. 5 is a block diagram showing one example of a device for automatically routing messages according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method for automatically routing information through a network uses a routing table, which is automatically updated. When a call is placed from a first communication unit (originator) to a second communication unit (target) in a network, a routing table is updated to show the identity of a “home” server that services the second communication unit (e.g., by providing access to the target subscriber's location information or other pertinent service subscription information). Thereafter, calls to the second communication unit that require applicable location or subscription information are directly routed to the target's home server, and, thereafter, to the second communication unit.

In many of these embodiments, a first message is sent to a first server. Responsively, a redirect message is received from the first server. The redirect message comprises identification of the designated home server associated with a destination mobile unit and a target range. The home server provides access to the target subscriber's location information or other pertinent service subscription information (e.g., via a Home Location Registrar, SIP Registrar, etc.). The target range includes a plurality of communication unit addresses that are likewise associated with the same server. A routing table with the target's home server and associated address range is updated. Subsequently, other messages sent from the first communication unit are sent directly to the target's home server, if applicable location and/or subscription information is not already known.

An update message may also be received from the destination server. The update message comprises information indicating that the target range of the server has changed. A new target range may also be indicated in the message.

Thus, changes to the routing tables are quickly and automatically made and result in the efficient transmission of information. Because the changes are made automatically, errors in the tables are reduced and the cost of operating the system is reduced. The changes are propagated automatically through the network and require no subsequent human interaction.

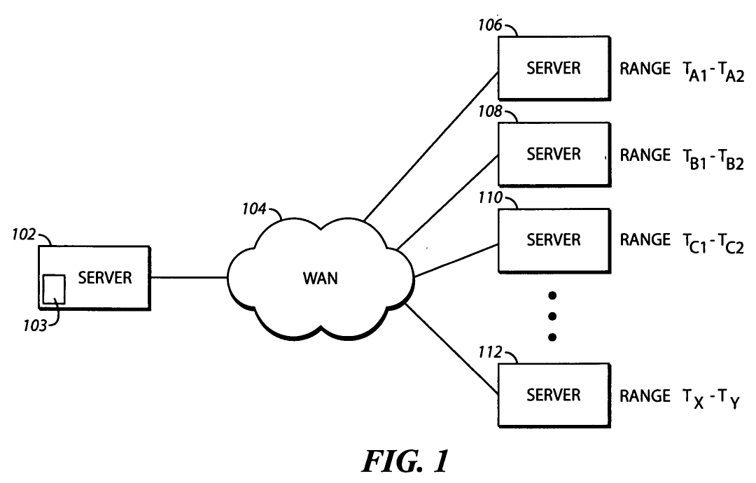

Referring now to FIG. 1, a system for automatically routing information in a wireless network is described. A server S_{O} 102 is coupled to a wide area network 104. The server includes a routing table 103. The routing table 103 may be any suitable data structure and may be stored in any suitable memory storage device, for example, a random access memory (RAM). Other memory devices may also be used.

A plurality of destination servers is also coupled to the network 104. The servers include server 106, 108, 110, and 112. Each of the servers 106, 108, 110, and 112, supports a range of communication unit addresses or a plurality of such address ranges. Each of the servers 106, 108, 110, and 112 acts as a home server for the associated communication units. For example, server 106 serves as the home server for communication units in the range T_{A1} to T_{A2}. Server 108 serves communication units in the range T_{B1} to T_{B2}. Server 110 serves communication units in the range T_{C1} to T_{C2}. Finally, server 112 serves communication units in the range T_{X} to T_{Y}.

The network 104 may be a wide area network (WAN) or other suitable network. For example, the network 104 may be a wireless network, a telephony network, or some combination of these networks. In addition, the various components that comprise the network 104 and that are needed to route information between two points in the network are not shown or described since these elements are well known in the art. For example, elements such as routers, servers, and controllers that route information through the network 104 are omitted.

In operation, the table 103 at the server 102 is updated with target range information automatically without the need for human intervention. For example, an initial message may be sent from the server 102 to one of the servers 106, 108, 110, or 112. The server 106, 108, 110, or 112 returns a redirect message to direct the server 102 to send the initial message to the proper server having the proper address range associated with the destination communication unit. In one example, the initial message may be a Session Initiation Protocol (SIP) Invite message. Other examples of messages that conform to other protocols are possible.

Thereafter, messages directed to the destination communication unit, or any other communication unit in the associated address range, will be sent directly to the proper server without the need of going through an intermediate server. Thus, the redirect message will not need to be sent and processed and the time needed to make connections between a source communication unit and a destination communication unit decreases.

Changes in the target ranges at the servers 106, 108, 110, and 112 may also be made automatically to the table 103 at the server 102. For instance, the servers 106, 108, 110, or 112 may send an update message to the server 102. The update message indicates that the target range for the identified server has changed and identifies that the new range of communication unit addresses served by the server 106, 108, 110, or 112. Thus, when a subsequent call is attempted to be made to a communication unit and the communication unit is no longer served by the server, a futile attempt to connect to that server is not made and the message is automatically routed to the appropriate home server.

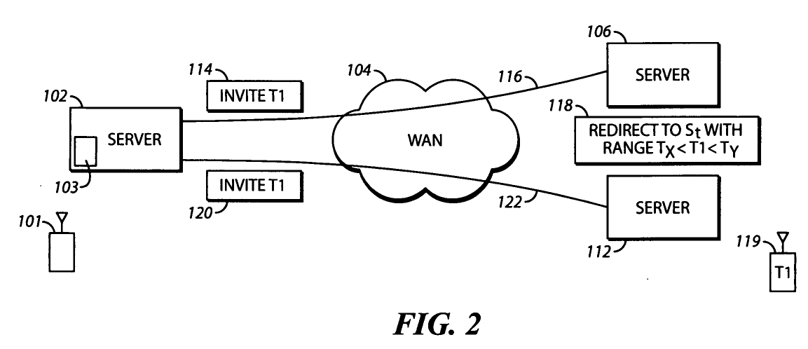

Referring now to FIG. 2, the routing of a first call in the network of FIG. 1 is described. A first mobile device 101 attempts to make a connection to a second mobile device 119. When the initial attempt is made, the mobile device 101 and the server S_{O} 102 may not have accurate information regarding the location of the target communication unit 119, nor its associated home server. In other words, the table 103 may have no information concerning the whereabouts of the target communication unit's 119 home server or the table 103 may point to an incorrect location for the target communication unit's 119 home server. Although the communication unit 119 is shown as a mobile unit, it will be understood that it may be any type of communication device.

The server 102 selects a server to receive the Invite message. The selection may be a random selection (of any server), a best guess of a target server based upon certain criteria that the server 102 has gathered, or may use what proves to be incorrect information stored in the table 103. In the case illustrated in FIG. 2, the server 102 finds no information in the table 103 and randomly selects the server 106 and, as a result, sends an Invite message 114 to the mobile device 119 to the server 106.

The message 114 is routed through the network 104 using conventional routing techniques over a communication link 116. The server 106 receives the message 114 and analyzes the message. The server 106 discovers that the message is addressed to the communication unit 119. However, the server 106 determines that it is not the designated home server for the target communication unit 119. Consequently, the server 106 sends a redirect message 118 to the server 102. The redirect message 118 returned to the server 102 includes the identity of the proper server 112 that should service the message 114 and the range of communication unit addresses that are similarly serviced by the server 112.

The redirect message 118 is sent to the server 102 via the network 104. The server 102 receives the redirect message 118. Consequently, the server 102 sends a second invite message 120 to the server 112 via the network 104 via a communication link 112. Also, the table 103 is updated in the server 102 to reflect the information received. As detailed below, subsequent calls to the communication unit 119 or other communication units in the range and being serviced by the server 112 are directly made to the server 112 and have no need to be processed by an intermediate server.

In this case, the second Invite message 120 is received at the server 112. The server 112 processes the Invite message and determines the applicable information regarding the target's communication unit (e.g., target location and destination call server). The connection between the first communication unit 101 and the second communication unit 119 is then established using standard call routing techniques, possibly involving another call server (e.g., if the target is currently roaming outside their home network service area).

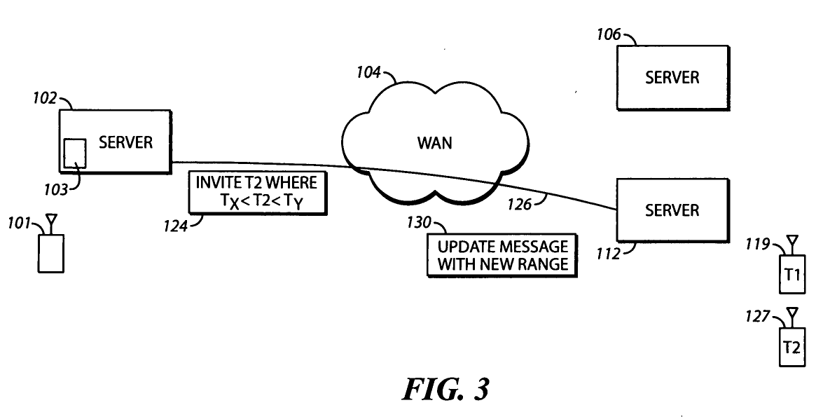

Referring now to FIG. 3, the routing of a second call made after the initial call shown in FIG. 2 is described. A second call is attempted between the communication unit 101 and the second communication unit 119. The communication unit 101 checks with the table 103 in the server 102 to see if the communication unit 119 is indicated in the table 103.

In this case, the table 103 has a listing of the range T_{X} to T_{Y} with the identity of the communication unit 119 falling within this range. Because the table 103 contains an entry identifying that the communication unit 119 is associated with the server 112, a direct connection can be made to the server 119 without the need of using an intermediate server. In this case, a connection 126 is used to transmit an Invite message 124 from the originating server 102 and the destination communication unit's 119 home server 112 via the network 104. The server 112 receives the message 124, determines the applicable information regarding the target's communication unit and establishes the call to communication unit 119 using standard call routing techniques, possibly involving another call server (e.g., if the target is currently roaming outside their home network service area). In other words, the message 124 does not have to be processed by the server 106 before being sent to the correct home server 112.

Calls made to other communication units served by the server 112 and indicated in the table 103 may also be made without the use of intermediate servers such as server 106. For example, a third communication unit 127 may also be within the range of communication unit addresses serviced by the server 112. In this case, a call may be made directly from the communication unit 101, or any other communication unit that is serviced by server 102, to the communication unit 127 via the network 104 and servers 102 and 112 without the usage or intervention of an intermediate server. Although shown as a mobile unit, it will be understood that communication unit 127 may be any type of communication device.

Changes in a supported target range at the server 112 are also made automatically to the table 103 at the server 102. The server 112 sends an update message 130 to the server 102. The update message 130 indicates that a target range for the server 112 has changed and identifies a new range of communication unit addresses served by the server 112. Thus, when a subsequent call is attempted to be made to a communication unit and the communication unit is no longer served by the server 112, a futile attempt to connect to the server 112 is not made and the connection can be made to the target communication unit via the correct server.

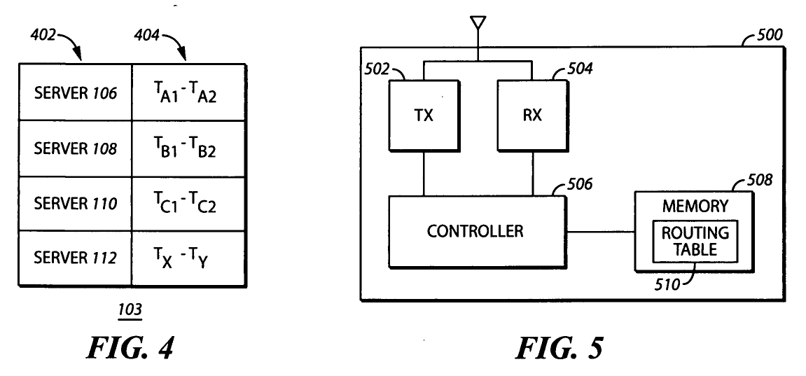

Referring now to FIG. 4, one example of the routing table 103 of FIGS. 1-4 is described. The routing table has a column 402 representing the identity of a server. Another column 404 represents the ranges of communication unit addresses served by the server indicated in the column 402. In this case, for example, server 106 serves as the home server for communication units in the address range T_{A1} to T_{A2}. Server 108 serves communication units in the address range T_{B1} to T_{B2}. Server 110 serves communication units in the address range T_{C1} to T_{C2}. Finally, server 112 serves communication units in the address range T_{X} to T_{Y}. The actual address ranges in the tables may be integers or some other value or identification relating to a communication unit.

Referring now to FIG. 5, a device 500 for automatically routing messages in a network includes a transmitter 502, a receiver 504, a controller 506, a memory 508 including a table 510. The controller 506 is programmed to send a message at an output of the transmitter 502 and receive a redirect message on the input of the receiver 504. The redirect message includes a destination server identifier and a range of target identifiers corresponding to a plurality of communication units.

The message may be, for instance, a Session Initiation Protocol (SIP) Invite message. The controller 506 may send the message to the destination communication unit via a destination server corresponding to the destination server identifier. The controller 506 may also directly send a second message to a destination communication unit via the destination server. An update message may be received and the routing table 510 may be updated based upon information in the update message.

Thus, changes to the routing tables are quickly and automatically made and result in the efficient transmission of information. Because the changes are made automatically rather than manually, errors in the tables are reduced and the cost of operating the system is reduced. The changes are also propagated automatically through the network and need no human interaction.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method of automatically routing a message between communication units in a network comprising:
sending a first message to a first server; and
responsively receiving a redirect message from the first server, the redirect message comprising identification of a destination server associated with a destination communication unit and a target range, the target range including a plurality of communication units associated with the destination server.

2. The method of claim 1 wherein sending the first message comprises sending a Session Initiation Protocol (SIP) Invite message.

3. The method of claim 1 further comprising sending at least a portion of the first message to the destination communication unit via the destination server.

4. The method of claim 3 further comprising subsequently directly sending a second message to the destination communication unit via the destination server.

5. The method of claim 1 further comprising updating a routing table with the destination server and target range.

6. The method of claim 1 further comprising receiving an update message from the destination server, the update message comprising information indicating the target range has changed and a new target range.

7. The method of claim 6 wherein the update message further comprises information indicating the new target range.

8. A device for automatically routing messages in a network comprising:
a transmitter having an output;
a receiver having an input;
a memory having a routing table stored therein; and
a controller coupled to the transmitter, receiver and memory, the controller programmed to send a first message on the output of the transmitter and receive a redirect message on the input of the receiver, the redirect message comprising a destination server identifier and a range of target identifiers corresponding to a plurality of communication units.

9. The device of claim 8 wherein the first message comprises a Session Initiation Protocol (SIP) Invite message.

10. The device of claim 8 wherein the controller further comprises means for sending the first message to the destination communication unit via a destination server corresponding to the destination server identifier.

11. The device of claim 10 wherein the controller further comprises means for directly sending a second message to a destination communication unit via the destination server.

12. The device of claim 8 wherein the input of the receiver receives an update message and wherein the controller further comprises means to update the routing table based upon information in the update message.

13. A method for automatically routing messages in a network comprising:
sending a first message from a source server to an intermediate server;
receiving the first message at the intermediate server, responsively determining a destination server, and target range, and sending information regarding the destination server and target range to the source server;
receiving the information regarding the destination server and target range at the source server and updating a routing table; and
directing calls destined for a communication unit mobile directly to the target server using the target range in the routing table.

14. The method of claim 13 wherein sending the first message comprises sending a Session Initiation Protocol (SIP) Invite message.

15. The method of claim 13 further comprising receiving an update message from the destination server comprising an indication that the target range has changed.
